(19) United States
(12) Patent Application Publication
(10) Pub. No.: US 2019/0299778 A1
(43) Pub. Date: Oct. 3, 2019

(54) TRANSFER CONTROL DEVICE

(71) Applicant: AISIN AI CO., LTD., Nishio-shi (JP)

(72) Inventor: Terumichi ASAI, Nishio-shi (JP)

(73) Assignee: AISIN AI CO., LTD., Nishio-shi (JP)

(21) Appl. No.: 16/197,770

(22) Filed: Nov. 21, 2018

(30) Foreign Application Priority Data
Mar. 29, 2018 (JP) 2018-066061

(51) Int. Cl. B60K 23/08; F16D 13/52; F16D 48/06

(52) U.S. Cl. CPC B60K 23/0808; F16D 13/52; F16D 48/06; B60K 2023/0858; F16D 2500/102; F16D 2500/70424; F16D 2500/1045; F16D 2500/3022; F16D 2500/304; F16D 2500/3148; F16D 2500/10431

(57) ABSTRACT

According to one embodiment, for example, a transfer control device controls a transfer that adjusts torque distribution to front wheels and rear wheels of a four-wheel vehicle and that includes a wet type multi-disc clutch and a piston. The transfer control device includes: a detector that detects, based on an output value of a sensor provided in the vehicle, whether a predetermined condition corresponding to a state immediately before ignition of the vehicle is turned ON is established; a controller that starts moving the piston when the detector detects that the predetermined condition is established, so that the multi-disc clutch is switched to a connected state from a disconnected state; and a storage that stores therein, while the piston is moved by the controller, information on a connection start state at which connection of the multi-disc clutch is started.

### CROSS-REFERENCE TO RELATED APPLICATIONS

This application is based upon and claims the benefit of priority from Japanese Patent Application No. 2018-066061, filed Mar. 29, 2018, the entire contents of which are incorporated herein by reference.

### FIELD

Embodiments described herein relate generally to a transfer control device.

### BACKGROUND

Conventionally, there has been known a transfer that adjusts torque distribution to front wheels and rear wheels of a four-wheel vehicle and that includes a wet type multi-disc clutch and a piston. The amount of torque transmitted by such a transfer is determined according to the pressing degree (pressing force) of the piston relative to the multi-disc clutch. An example of related art is described in Japanese Patent Application Laid-open No. 2009-197955.

### SUMMARY

In order to accurately control the amount of torque transmitted by the transfer as described above, the pressing degree of the piston relative to the multi-disc clutch needs to be accurately controlled.

Meanwhile, there has been developed a technique to accurately control the pressing degree of the piston relative to the multi-disc clutch, by storing (learning) information on the point (touch point) at which the piston and the multi-disc clutch start coming into contact with each other, and by making the learned information as a reference for subsequent controls. For example, such learning is performed at a predetermined time interval while the ignition of the vehicle is turned ON.

On the other hand, because of its nature, the total thickness of the wet type multi-disc clutch is easily changed by the influence of temperature, influence of moisture in the lubricating oil and air, influence of restoration degree (restoration speed) after the pressing applied by the piston is released, and the like. In particular, during a period from when the ignition of the vehicle is turned OFF to when the ignition is turned ON again, the state of the vehicle changes from the warming-up completion state to the cold state with the lapse of time. In this case, the temperature, the moisture in the lubricating oil and air, and the restoration degree of the multi-disc clutch tend to change significantly, hence the previously learned information may become inaccurate. Thus, in this case, if the previously learned information is used when the ignition of the vehicle is turned ON again after the ignition is turned OFF, the control accuracy of the amount of torque transmitted may be deteriorated. Accordingly, for example, the wheels may slip when the vehicle is started immediately after the ignition of the vehicle is turned ON, due to an insufficient amount of torque transmitted, thereby making the vehicle behave in an unstable manner.

Therefore, it is desired to prevent the learned result of the information on the point at which the piston and the multi-disc clutch start coming into contact with each other from becoming inaccurate with the lapse of time.

According to one embodiment, for example, a transfer control device controls a transfer that adjusts torque distribution to a front wheel and a rear wheel of a four-wheel vehicle and that includes a wet type multi-disc clutch and a piston. The transfer control device includes: a detector that detects, based on an output value of a sensor provided in the vehicle, whether a predetermined condition corresponding to a state immediately before ignition of the vehicle is turned ON is established; a controller that starts moving the piston when the detector detects that the predetermined condition is established, so that the multi-disc clutch is switched to a connected state from a disconnected state; and a storage that stores therein, while the piston is moved by the controller, information on a connection start state at which connection of the multi-disc clutch is started.

With the configuration described above, the information on the connection start state, in other words, the information on the point (touch point) at which the piston and the wet type multi-disc clutch start coming into contact with each other is stored (learned) immediately before the ignition of the vehicle is turned ON. Thus, it is possible to reduce the lapse of time from when the learning is performed until when the learning result is actually used. As a result, it is possible to prevent the learning result from becoming inaccurate with the lapse of time.

According to one embodiment of the transfer control device, for example, the controller moves the piston by driving an actuator. The transfer control device further includes: a current monitor that monitors an electric current value of the actuator; and a position monitor that monitors a driving position of the actuator. The storage stores therein, as the information on the connection start state, the driving position monitored by the position monitor when the electric current value monitored by the current monitor becomes equal to or more than a predetermined value. With such a configuration, it is possible to easily store (learn) the information on the connection start state, on the basis of the electric current value of the actuator.

According to one embodiment of the transfer control device, for example, the detector detects that the predetermined condition is established, upon establishing a first condition in which seating of a person on a seat of the vehicle is detected based on an output value of a weight sensor serving as the sensor that detects weight applied to the seat. With such a configuration, it is possible to easily detect a sign of the ignition of the vehicle to be turned ON, on the basis of the first condition.

According to one embodiment of the transfer control device, for example, even if the first condition not established, the detector detects that the predetermined condition is established when any one of conditions is established, the conditions including: a second condition in which opening of a door of the vehicle is detected based on an output value of an opening/closing sensor serving as the sensor that detects opening and closing of the door; a third condition in which fastening of a seatbelt of the vehicle is detected based on an output value of a seatbelt sensor serving as the sensor that detects fastening of the seatbelt; and a fourth condition in which an operation carried out on a clutch or a brake of the vehicle is detected based on an output value of an operation sensor that detects an operation carried out on the clutch or the brake. With such a configuration, it is possible to more certainly detect a sign of the ignition of the vehicle to be turned ON, on the basis of a plurality of the conditions (first condition to fourth condition).

### BRIEF DESCRIPTION OF THE DRAWINGS

FIG. 1 is an exemplary and schematic block diagram illustrating a configuration of a vehicle according to one embodiment;

FIG. 2 is an exemplary and schematic diagram illustrating a configuration of a transfer according to the embodiment;

FIG. 3 is an exemplary and schematic block diagram illustrating a functional configuration of a transfer control device according to the embodiment;

FIG. 4 is an exemplary and schematic graph for explaining a connection start state of the transfer according to the embodiment; and

FIG. 5 is an exemplary and schematic flowchart illustrating a series of processes executed by the transfer control device according to the embodiment.

### DETAILED DESCRIPTION

Hereinafter, one embodiment of the present disclosure will be described with reference to the accompanying drawings. The structure of the embodiment described below and the operations and results (effects) provided by the structure are merely examples, and not limited to the following description.

First, the configuration (structure) of the embodiment will be described.

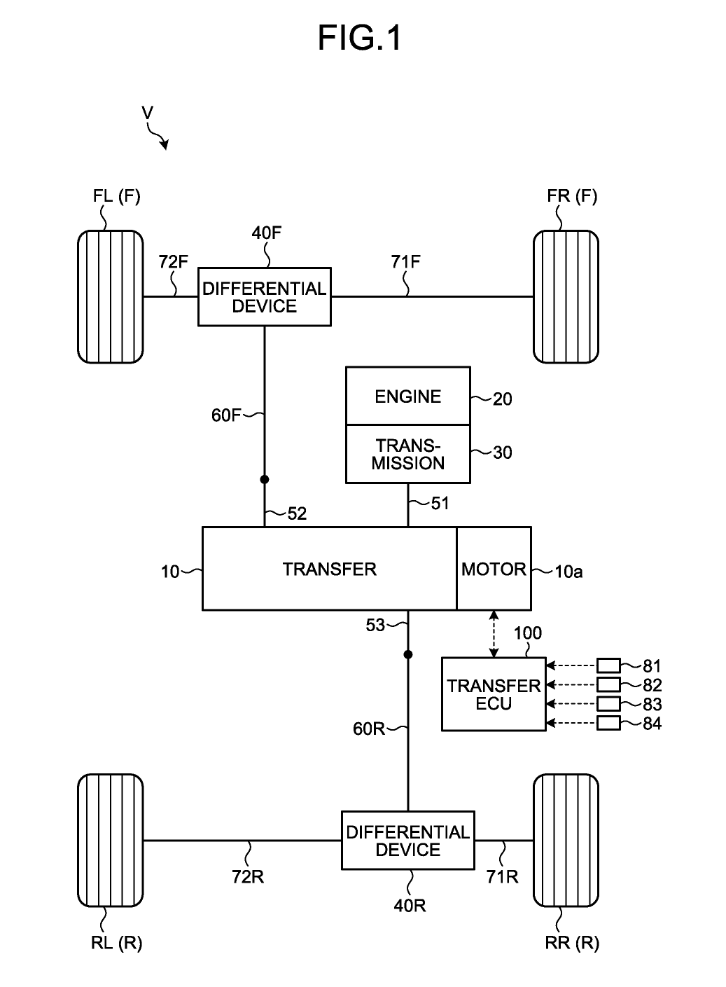

FIG. 1 is an exemplary and schematic block diagram illustrating a configuration of a vehicle V according to one embodiment. As illustrated in FIG. 1, the vehicle V according to the embodiment is configured as a four-wheel automobile including a pair of front wheels F (a left front wheel FL and a right front wheel FR) and a pair of rear wheels R (a left rear wheel RL and a right rear wheel RR). Note that the technique of the embodiment is applicable to any vehicle, as long as the vehicle includes a transfer similarly configured as a transfer 10 to be described below.

The vehicle V according to the embodiment includes the transfer 10 that adjusts torque distribution to the front wheels F and the rear wheels R. The vehicle V is configured so as to be switchable between four-wheel drive and two-wheel drive by the transfer 10.

More specifically, the transfer 10 includes an input shaft 51 and two output shafts 52 and 53. The input shaft 51 is connected to a transmission 30 connected to an engine 20. The output shaft 52 is connected to a differential device 40F at the front wheels F side via a propeller shaft 60F at the front wheels F side. The output shaft 53 is connected to a differential device 40R at the rear wheels R side via a propeller shaft 60R at the rear wheels R side.

The differential device 40F distributes the torque input via the propeller shaft 60F, between the right front wheel FR connected to a vehicle shaft 71F and the left front wheel FL connected to a vehicle shaft 72F. Similarly, the differential device 40R distributes the torque input via the propeller shaft 60R, between the right rear wheel RR connected to a vehicle shaft 71R and the left rear wheel RL connected to a vehicle shaft 72R.

With such a configuration, the transfer 10 suitably distributes the torque of the engine 20 input via the input shaft 51 to at least one of the front wheels F and the rear wheels R via at least one of the output shafts 52 and 53, and switches between the four-wheel drive and the two-wheel drive of the vehicle V.

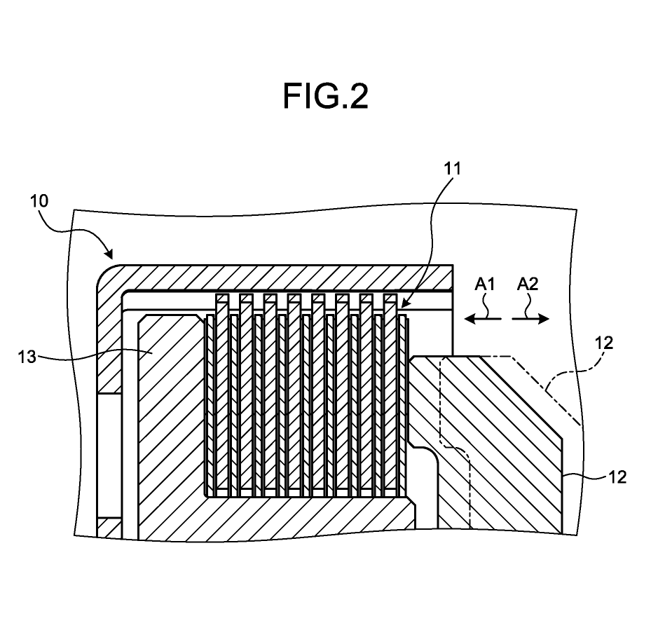

The transfer 10 is driven by a motor 10a serving as an actuator. Although details will be described below, the transfer 10 includes a wet type multi-disc clutch 11 and a piston 12 (see both in FIG. 2). The multi-disc clutch 11 is connected and disconnected in response to the piston 12 moving by the motor 10a. In a connected state in which the multi-disc clutch 11 is connected, the vehicle V is driven by four-wheel drive, and in a disconnected state in which the multi-disc clutch 11 is disconnected, the vehicle V is driven by two-wheel drive.

The motor 10a is operated under the control of a transfer electronic control unit (ECU) 100 configured as a microcomputer having a hardware configuration such as a processor and memory. The transfer ECU 100 can use output values from various sensors provided in the vehicle V for controlling the motor 10a. For example, in the example illustrated in FIG. 1, the transfer ECU 100 is configured to receive an output value of a weight sensor 81 that detects the weight applied to a seat (not illustrated) of the vehicle V, an output value of an opening/closing sensor 82 that detects the opening and closing of a door (not illustrated) of the vehicle V, an output value of a seatbelt sensor 83 that detects the fastening of a seatbelt (not illustrated) of the vehicle V, and an output value of an operation sensor 84 that detects an operation (for example, by a driver) carried out on the clutch or brake (both not illustrated) of the vehicle V.

In the embodiment, in addition to the transfer ECU 100 described above, the vehicle V may also include various ECUs corresponding to various functions mounted in the vehicle V such as a body ECU (not illustrated) that controls the mechanism provided on the body (not illustrated) of the vehicle V, a travel control ECU (not illustrated) that controls the traveling of the vehicle V, and the like.

FIG. 2 is an exemplary and schematic diagram illustrating a configuration of the transfer 10 according to the embodiment. As illustrated in FIG. 2, the transfer 10 according to the embodiment includes: the wet type multi-disc clutch 11 having a plurality of clutch plates; and the piston 12 configured to be capable of pressing the multi-disc clutch 11. The multi-disc clutch 11 and the piston 12 are supported by a clutch hub 13.

The piston 12 can move in an arrow Al direction that is a direction approaching the multi-disc clutch 11 and in an arrow A2 direction that is a direction away from the multi-disc clutch 11 by the motor 10a (see FIG. 1). When the piston 12 moves in the arrow A1 direction from a state that the piston and the multi-disc clutch 11 are in contact with each other, the multi-disc clutch 11 is pressed by the piston 12. As a result, the clutch plates of the multi-disc clutch 11 come into close contact with each other, thereby making the multi-disc clutch 11 in the connected state. On the other hand, when the piston 12 moves in the arrow A2 direction from a state that the piston 12 and the multi-disc clutch 11 are in contact with each other, the piston 12 separates from the multi-disc clutch 11. As a result, the clutch plates of the multi-disc clutch 11 separate from one another, thereby making the multi-disc clutch 11 in the disconnected state.

In the transfer 10 including the multi-disc clutch 11 and the piston 12 as in the embodiment, the amount of torque transmitted by the transfer 10 is determined according to the pressing degree (pressing force) of the piston 12 relative to the multi-disc clutch 11. Consequently, in order to accurately control the amount of torque transmitted by the transfer 10, the pressing degree of the piston 12 relative to the multi-disc clutch 11 needs to be accurately controlled.

Meanwhile, there has been developed a technique to obtain required accuracy by storing (learning) the information on the point (touch point) at which the piston 12 and the multi-disc clutch 11 start coming into contact with each other, and by making the learned information as a reference for subsequent controls. The touch point corresponds to a state in which a gap between the clutch plates of the multi-disc clutch 11 is filled (play is eliminated). For example, the information on the touch point such as the above is learned at a predetermined time interval while the ignition of the vehicle V is turned ON.

On the other hand, because of its nature, the total thickness (thickness in the direction toward which the clutch plates are stacked) of the wet type multi-disc clutch 11 as in the embodiment is easily changed by the influence of temperature, influence of moisture in the lubricating oil and air, influence of restoration degree (restoration speed) after the pressing applied by the piston 12 is released, and the like. In particular, during a period from when the ignition of the vehicle V is turned OFF to when the ignition is turned ON again, the state of the vehicle V changes from the warming-up completion state to the cold state with the lapse of time. In this case, the temperature, the moisture in the lubricating oil and air, and the restoration degree of the multi-disc clutch 11 tend to change significantly, hence the previously learned information may become inaccurate. Thus, in this case, if the previously learned information is used when the ignition of the vehicle V is turned ON again after the ignition is turned OFF, the control accuracy of the amount of torque transmitted may be deteriorated. Accordingly, for example, the wheels (front wheels F, rear wheels R, or the like) may slip when the vehicle V is started immediately after the ignition of the vehicle V is turned ON, due to an insufficient amount of torque transmitted, thereby making the vehicle V behave in an unstable manner.

Therefore, the embodiment prevents the learning result of the information on the point (touch point) at which the piston 12 and the wet type multi-disc clutch 11 start coming into contact with each other from becoming inaccurate with the lapse of time, by implementing a transfer control device 300 to be described below in the transfer ECU 100.

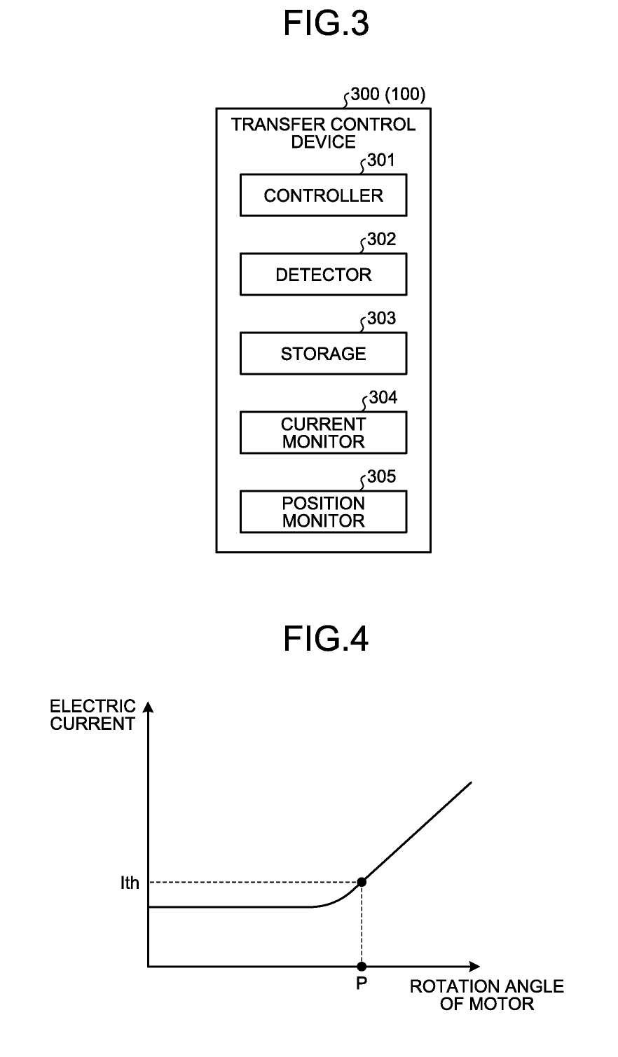

FIG. 3 is an exemplary and schematic block diagram illustrating a functional configuration of the transfer control device 300 according to the embodiment. The function module group illustrated in FIG. 3 is implemented by cooperation between software and hardware. In other words, the function module group illustrated in FIG. 3 is implemented as a result that the processor of the transfer ECU 100 reads out and executes a predetermined control program stored in memory and the like. Note that in the embodiment a part or all of the function module group illustrated in FIG. 3 may be implemented only by dedicated hardware (circuitry).

As illustrated in FIG. 3, the transfer control device 300 includes a controller 301, a detector 302, a storage 303, a current monitor 304, and a position monitor 305.

The controller 301 controls the motor 10a that is driven to move the piston 12 of the transfer 10. For example, the controller 301 provides a target electric current value to the motor 10a and monitors an electric current value of the motor 10a.

The detector 302 detects whether a predetermined condition corresponding to a state immediately before the ignition of the vehicle V is turned ON (from OFF) is established, on the basis of the output values of the sensors provided in the vehicle V such as the weight sensor 81, the opening/closing sensor 82, the seatbelt sensor 83, and the operation sensor 84 as described above. The predetermined condition corresponds to a condition indicating a sign of the ignition of the vehicle V to be turned ON from OFF.

For example, upon establishing a first condition in which the seating of a person on a seat (not illustrated) of the vehicle V is detected on the basis of the output value of the weight sensor 81, the detector 302 detects that the predetermined condition is established. Moreover, even if the first condition is not established, the detector 302 detects that the predetermined condition is established, upon establishing any one of a second condition, a third condition, and a fourth condition. In the second condition, the opening of a door (not illustrated) of the vehicle V is detected on the basis of the output value of the opening/closing sensor 82. In the third condition, the fastening of a seatbelt (not illustrated) of the vehicle V is detected on the basis of the output value of the seatbelt sensor 83. In the fourth condition, an operation carried out on the clutch or brake (both not illustrated) of the vehicle V is detected on the basis of the output value of the operation sensor 84.

In the embodiment, when the detector 302 detects that the predetermined condition is established, the controller 301 starts moving the piston 12 to switch the multi-disc clutch 11 to the connected state from the disconnected state. Then, while the piston 12 is moved by the controller 301, the storage 303 stores therein (learns) the information on a connection start state at which the connection of the multi-disc clutch 11 is started.

The information on the connection start state is information similar to the information on the touch point as described above at which the piston 12 and the multi-disc clutch 11 start coming into contact with each other. For example, in the embodiment, as will be described below, the driving position (for example, rotation angle) of the motor 10a at the timing when the electric current value of the motor 10a has risen to a predetermined value (threshold) will be stored, as the information on the connection start state.

In other words, in the embodiment, the current monitor 304 monitors the electric current value of the motor 10a, and the position monitor 305 monitors the driving position (for example, rotation angle) of the motor 10a. The storage 303 stores therein the driving position monitored by the position monitor 305 at which the electric current value monitored by the current monitor 304 becomes equal to or more than a predetermined value (threshold) corresponding to the connection start state, as the information on the connection start state.

FIG. 4 is an exemplary and schematic graph for explaining the connection start state of the transfer 10 according to the embodiment. The graph illustrated in FIG. 4 exemplarily and schematically illustrates a relationship between the rotation angle (horizontal axis) of the motor 10a and the electric current value (vertical axis) of the motor 10a, when the motor 10a is driven and the piston 12 is gradually brought close to the multi-disc clutch 11 from the position away from the multi-disc clutch 11. The rotation angle of the motor 10a is a value that can be monitored by the position monitor 305, and the electric current value of the motor 10a is a value that can be monitored by the current monitor 304.

In this example, when the motor 10a is driven and the piston 12 is gradually brought close to the multi-disc clutch 11 from the position away from the multi-disc clutch 11, load will not be practically generated until the piston 12 comes into contact with the multi-disc clutch 11. Thus, in this case, the electric current value of the motor 10a is substantially the same. In contrast, when the piston 12 starts coming into contact with the multi-disc clutch 11, load is gradually increased. Thus, in this case, the electric current value of the motor 10a rises gradually. Consequently, when the rise in the electric current value of the motor 10a is detected, it is possible to acquire the information on the connection start state of the multi-disc clutch 11.

Based on the above description, in the example illustrated in FIG. 4, a rotation angle P of the motor 10a when the electric current value of the motor 10a starts rising and reaches a predetermined threshold Ith corresponds to the information on the connection start state of the multi-disc clutch 11. Thus, in the example illustrated in FIG. 4, the storage 303 stores therein the rotation angle P of the motor 10a as the information on the connection start state.

Next, a control operation of the embodiment will be described.

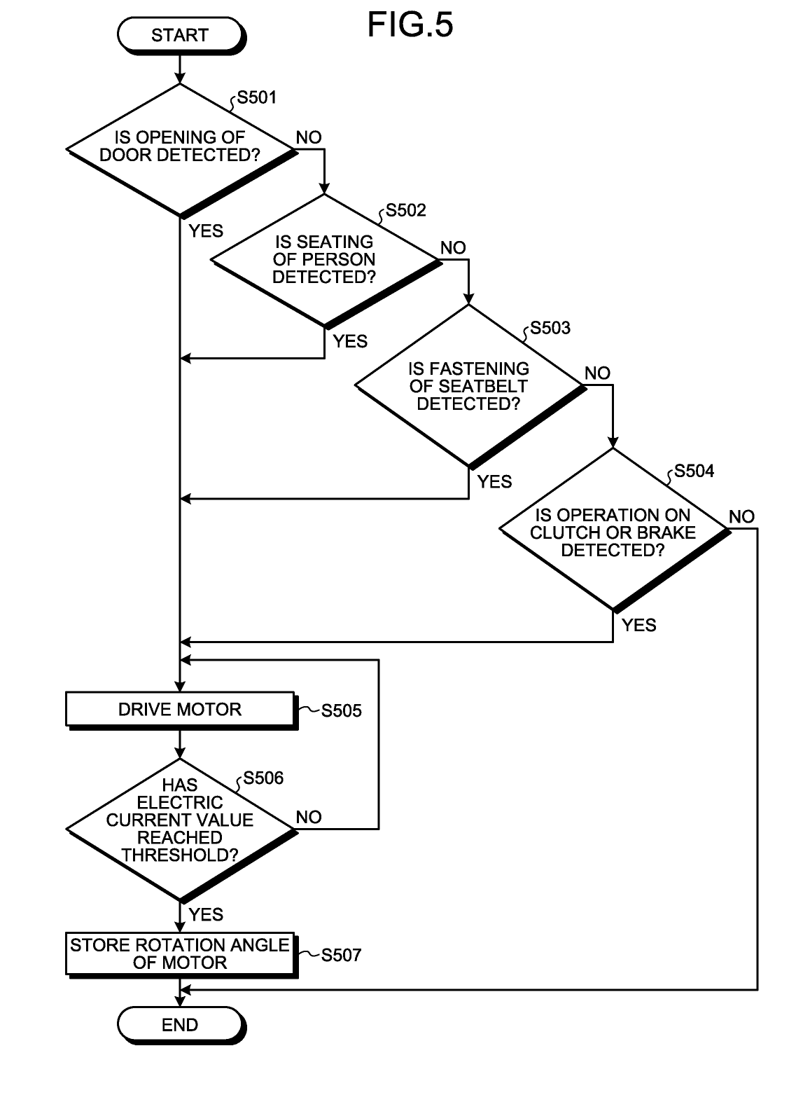

FIG. 5 is an exemplary and schematic flowchart illustrating a series of processes executed by the transfer control device 300 according to the embodiment. For example, the processing flow illustrated in FIG. 5 is executed when the transfer ECU 100 is activated in response to the activation of the body ECU (not illustrated). The body ECU (not illustrated) is activated in response to unlocking of a door (not illustrated) and the like executed when a person gets in the vehicle V the ignition of which is turned OFF.

In the processing flow illustrated in FIG. 5, first, at S501, the detector 302 determines whether the opening of the door (not illustrated) of the vehicle V is detected, in other words, whether the second condition described above is established, on the basis of the output value of the opening/closing sensor 82.

At S501, when it is determined that the opening of the door (not illustrated) is not detected, the process proceeds to S502. Then, at S502, the detector 302 determines whether the seating of a person on a seat (not illustrated) of the vehicle V is detected, in other words, whether the first condition described above is established, on the basis of the output value of the weight sensor 81.

At S502, when it is determined that the seating of a person on the seat (not illustrated) is not detected, the process proceeds to S503. Then, at S503, the detector 302 determines whether the fastening of a seatbelt (not illustrated) of the vehicle V is detected, in other words, whether the third condition described above is established, on the basis of the output value of the seatbelt sensor 83.

At S503, when it is determined that the fastening of the seatbelt (not illustrated) is not detected, the process proceeds to S504. Then, at S504, the detector 302 determines whether an operation carried out on the brake or clutch (both not illustrated) of the vehicle V is detected, in other words, whether the fourth condition described above is established, on the basis of the output value of the operation sensor 84.

At S504, when it is determined that the operation carried out on the brake or clutch (both not illustrated) is not detected, it means that there is no sign of the ignition of the vehicle V to be turned ON from OFF. Consequently, in this case, the process is finished.

On the other hand, at S504, when it is determined that the operation carried out on the brake or clutch (both not illustrated) is detected, it means that there is a sign of the ignition of the vehicle V to be turned ON from OFF. Consequently, the process proceeds to S505 to store (learn) the information on the connection start state of the multi-disc clutch 11. It also means that there is a sign of the ignition of the vehicle V to be turned ON from OFF, when it is determined that the opening of the door (not illustrated) is detected at S501, when it is determined that the seating of a person on the seat (not illustrated) is detected at S502, and when it is determined that the fastening of the seatbelt (not illustrated) is detected at S503. Consequently, also in these cases, the process proceeds to S505.

At S505, the controller 301 drives the motor 10a. Then, at S506, the current monitor 304 determines whether the electric current value of the motor 10a has reached a predetermined value (threshold) corresponding to the connection start state of the multi-disc clutch 11.

At S506, when it is determined that the electric current value of the motor 10a has not reached the threshold, the process returns to S505, and the driving of the motor 10a is continued. On the other hand, at S506, when it is determined that the electric current value of the motor 10a has reached the threshold, the process proceeds to S507.

At S507, the storage 303 stores (learns) the rotation angle of the motor 10a at a timing when the electric current value of the motor 10a has reached the threshold, on the basis of the monitor result of the position monitor 305. The learning result is subsequently used when the ignition of the vehicle V is actually turned ON, and when the switching between the two-wheel drive and the four-wheel drive is carried out and the like. The process is then finished.

As described above, the transfer control device 300 according to the embodiment is configured to control the transfer 10 that adjusts torque distribution to the front wheels F and the rear wheels R of the four-wheel vehicle V and that includes the multi-disc clutch 11 and the piston 12. The transfer control device 300 includes the detector 302, the controller 301, and the storage 303. The detector 302 detects whether the predetermined condition corresponding to the state immediately before the ignition of the vehicle V is turned ON is established, on the basis of the output value of the sensors provided in the vehicle V. The controller 301 starts moving the piston 12 to switch the multi-disc clutch 11 to the connected state from the disconnected state, when the detector 302 detects that the predetermined condition is established. The storage 303 stores therein the information on the connection start state at which the connection of the multi-disc clutch 11 is started, while the piston 12 is moved by the controller 301.

With the configuration described above, the information on the connection start state, in other words, the information on the point (touch point) at which the piston 12 and the wet type multi-disc clutch 11 start coming into contact with each other is stored (learned), immediately before the ignition of the vehicle V is turned ON. Consequently, it is possible to reduce the lapse of time from when the learning is performed until when the learning result is actually used. As a result, it is possible to prevent the learning result from becoming inaccurate with the lapse of time.

In the transfer control device 300 according to the embodiment, the controller 301 moves the piston 12 by driving the motor 10a. Moreover, the transfer control device 300 includes the current monitor 304 that monitors the electric current value of the motor 10a, and the position monitor 305 that monitors the driving position (rotation angle) of the motor 10a. The storage 303 stores the driving position monitored by the position monitor 305 at which the electric current value monitored by the current monitor 304 becomes equal to or more than a predetermined value (threshold) corresponding to the connection start state described above, as the information on the connection start state. With such a configuration, it is possible to easily store (learn) the information on the connection start state, on the basis of the electric current value of the motor 10a.

Moreover, in the transfer control device 300 according to the embodiment, the detector 302 detects that the predetermined condition described above is established, upon establishing the first condition in which the seating of a person on a seat (not illustrated) of the vehicle V is detected on the basis of the output value of the weight sensor 81 serving as a sensor that detects the weight applied to the seat. With such a configuration, it is possible to easily detect a sign of the ignition of the vehicle V to be turned ON, on the basis of the first condition.

Furthermore, in the transfer control device 300 according to the embodiment, even if the first condition not established, the detector 302 detects that the predetermined condition described above is established when at least one of the second condition, the third condition, and the fourth condition is established. In the second condition, the opening of the door (not illustrated) of the vehicle V is detected on the basis of the output value of the opening/closing sensor 82 serving as a sensor that detects the opening and closing of the door. In the third condition, the fastening of the seatbelt (not illustrated) of the vehicle V is detected on the basis of the output value of the seatbelt sensor 83 serving as a sensor that detects the fastening of the seatbelt. In the fourth condition, the operation carried out on the clutch or brake (both not illustrated) of the vehicle V is detected on the basis of the output value of the operation sensor 84 that detects the operation carried out on the clutch or brake. With such a configuration, it is possible to more certainly detect a sign of the ignition of the vehicle V to be turned ON, on the basis of a plurality of the conditions (first condition to fourth condition).

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A transfer control device that controls a transfer to adjust torque distribution to a front wheel and a rear wheel of a four-wheel vehicle, the transfer including a wet type multi-disc clutch and a piston, the transfer control device comprising:
a detector that detects, based on an output value of a sensor provided in the vehicle, whether a predetermined condition corresponding to a state immediately before ignition of the vehicle is turned ON is established;
a controller that starts moving the piston when the detector detects that the predetermined condition is established, so that the multi-disc clutch is switched to a connected state from a disconnected state; and
a storage that stores therein, while the piston is moved by the controller, information on a connection start state at which connection of the multi-disc clutch is started.

2. The transfer control device according to claim 1, wherein
the controller moves the piston by driving an actuator,
the transfer control device further comprises:
a current monitor that monitors an electric current value of the actuator; and
a position monitor that monitors a driving position of the actuator, and
the storage stores therein, as the information on the connection start state, the driving position monitored by the position monitor when the electric current value monitored by the current monitor becomes equal to or more than a predetermined value.

3. The transfer control device according to claim 1, wherein
the detector detects that the predetermined condition is established, upon establishing a first condition in which seating of a person on a seat of the vehicle is detected based on an output value of a weight sensor serving as the sensor that detects weight applied to the seat.

4. The transfer control device according to claim 2, wherein
the detector detects that the predetermined condition is established, upon establishing a first condition in which seating of a person on a seat of the vehicle is detected based on an output value of a weight sensor serving as the sensor that detects weight applied to the seat.

5. The transfer control device according to claim 3, wherein
even if the first condition not established, the detector detects that the predetermined condition is established when any one of conditions is established, the conditions including:
a second condition in which opening of a door of the vehicle is detected based on an output value of an opening/closing sensor serving as the sensor that detects opening and closing of the door;
a third condition in which fastening of a seatbelt of the vehicle is detected based on an output value of a seatbelt sensor serving as the sensor that detects fastening of the seatbelt; and
a fourth condition in which an operation carried out on a clutch or a brake of the vehicle is detected based on an output value of an operation sensor that detects an operation carried out on the clutch or the brake.

6. The transfer control device according to claim 4, wherein
even if the first condition not established, the detector detects that the predetermined condition is established when any one of conditions is established, the conditions including:
a second condition in which opening of a door of the vehicle is detected based on an output value of an opening/closing sensor serving as the sensor that detects opening and closing of the door;
a third condition in which fastening of a seatbelt of the vehicle is detected based on an output value of a seatbelt sensor serving as the sensor that detects fastening of the seatbelt; and
a fourth condition in which an operation carried out on a clutch or a brake of the vehicle is detected based on an output value of an operation sensor that detects an operation carried out on the clutch or the brake.
